(19) United States
(12) Patent Application Publication
(10) Pub. No.: US 2003/0220837 A1
(43) Pub. Date: Nov. 27, 2003

(54) System and method for selecting a website affiliate based on maximum potential revenue generation

(76) Inventor: Takao Asayama, Sunnyvale, CA (US)

Correspondence Address: SQUIRE, SANDERS & DEMPSEY L.L.P, 600 HANSEN WAY, PALO ALTO, CA, 94304-1043, US

(21) Appl. No.: 10/334,933

(22) Filed: Dec. 31, 2002

Related U.S. Application Data
(60) Provisional application No. 60/382,966, filed on May 24, 2002.

(51) Int. Cl. G06F 17/60

(52) U.S. Cl. 705/14

(57) ABSTRACT

The system comprises a database and a dispatcher engine. The database includes data for use in selecting an affiliate having maximum potential referral revenue generation, such as past revenue generation, user purchase history, affiliate website characteristics, user demographic data and affiliate conversion ratios. The dispatcher engine selects an affiliate website to maximize potential referral revenue generation based on data stored in the database and sends an advertisement for the affiliate to a web server for display.

### PRIORITY REFERENCE TO PRIOR APPLICATIONS

This application claims benefit of and incorporates by reference patent application serial No. 60/382,966, entitled “System And Method For Selecting A Website Affiliate Based On Maximum Potential Revenue Generation,” filed on May 24, 2002, by inventor Takao Asayama.

### TECHNICAL FIELD

This invention relates generally to web affiliates, and more particularly, but not exclusively, provides a system and method for maximizing referral website revenue generated from web affiliate programs.

### BACKGROUND

Conventional web affiliate programs enable a website owner to provide links on his or her website to web affiliates. A user clicking on the link directs the user to an affiliate and enables the website owner to earn a fixed fee or a percentage of revenue earned by the affiliate from the user spending money on the affiliate website. For example, a website owner may have an affiliate link to Amazon.com®. When a user clicks through the link to Amazon.com and purchases something, the website owner earns a commission for referring the user. The commission may be fixed, such as $1 per sale, or may be a percentage of sales, such as 5% of sales. Alternatively, the commission may have a graduated commission scale, such as 1% for the first $1,000 in sales and 2% for anything above the first $1,000 in sales.

Further, web affiliate programs can include affiliate websites in multiple languages as well as covering a plurality of products lines. Accordingly, due to the multiple variables of web affiliates including language, products, and commissions, a new system and method for selecting website affiliates are needed.

### SUMMARY

The present invention provides a system for selecting a web affiliate from a group of affiliates so as to maximize potential revenue for a referring website. The system comprises a dispatcher engine, a tracking engine, and a database. The dispatcher engine selects web affiliates for referrals in real time based on data stored in the database and sends advertisements corresponding to selected affiliates to web servers for display to users. The tracking engine tracks revenue generated, conversion ratios, and user purchase history at affiliates and stores it in the database. The database includes data corresponding to revenue generated by each affiliate for referring websites, conversion ratios for each affiliate, user purchase history and characteristics, and affiliate characteristics, such as language and IP address.

The present invention further provides a method for maximizing potential revenue generated from web affiliate programs. The method comprises: receiving, from a web server, a request for an advertisement for a web affiliate; selecting a web affiliate offering the maximum potential revenue generation; and sending, to the web server, an advertisement for the selected web affiliate.

The system and method may advantageously increase revenue generated from web affiliate programs.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a network system in accordance with an embodiment of the present invention;

FIG. 2 is a block diagram illustrating an example computer in accordance with an embodiment of the present invention;

FIG. 3 is a block diagram illustrating the dispatcher system of the dispatcher of FIG. 1;

FIG. 4 is a block diagram illustrating the database of the dispatcher system of FIG. 3; and

FIG. 5 is a flowchart illustrating a method for a dispatcher to choose a web affiliate to maximize potential revenue generation.

### DETAILED DESCRIPTION OF THE ILLUSTRATED EMBODIMENTS

The following description is provided to enable any person of ordinary skill in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

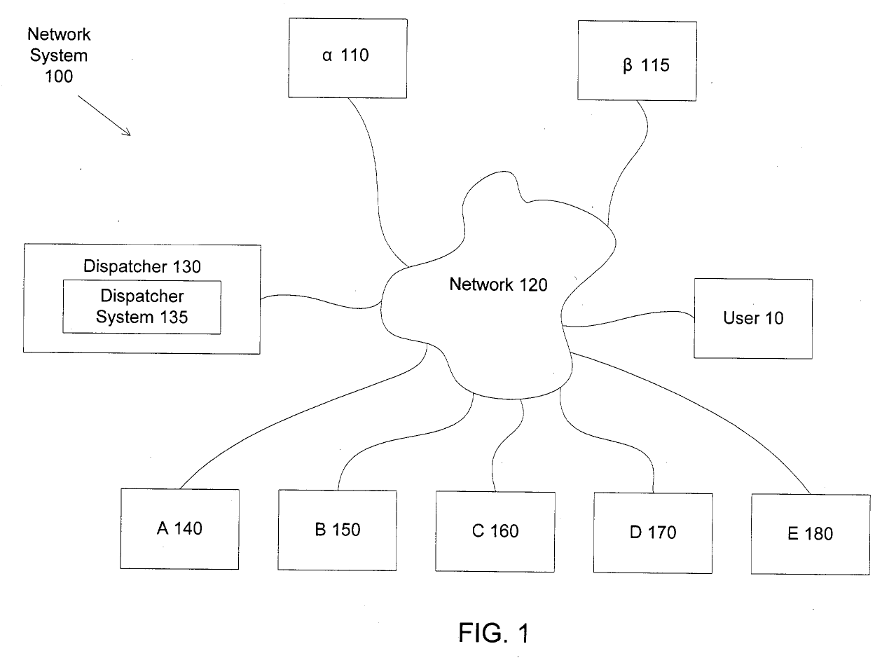

FIG. 1 is a block diagram illustrating a network system 100 in accordance with an embodiment of the present invention. System 100 comprises a dispatcher 130, websites α 110 and β 115, affiliates A 140, B 150, C 160, D 170, and E 180, and a user 10 all communicatively coupled together, via wired or wireless techniques, e.g., via a network 120 such as the Internet. In another embodiment, network system 100 may include additional or fewer users, websites, and/or affiliates.

Websites α 110 and β 115 may include any type of website with affiliate advertising. For example, websites α 110 and β 115 may include news web pages, online shopping web pages, search engines, subscription web pages, etc. User 10 may include a client device, such as a desktop computer or mobile device. User 10 is capable of communicating with website α 110 and/or website β 115 and may click through an advertisement or other gateway supplied by dispatcher 130 to one of the website affiliates A 140, B 150, C 160, D 170, and E 180.

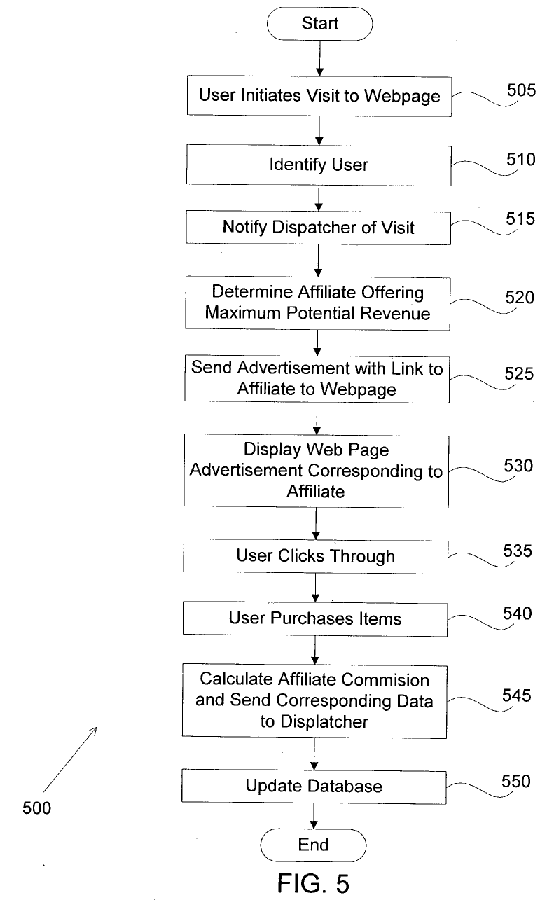

Dispatcher 130 includes a dispatcher system 135 that sends an advertisement to a web server corresponding to an affiliate offering the maximum potential revenue generation. The dispatcher system 135 determines the affiliate offering the maximize potential revenue generation based on historical revenue generation data and other data stored in a database, as will be discussed in further detail in conjunction with FIG. 3. and FIG. 5. The dispatcher system 135 also updates a database with data corresponding to revenue generated based on the determination.

Web affiliates A 140, B 150, C 160, D 170, and E 180 are websites that can generate revenue for a referring website, such as website α 110 or website β 115. Web affiliates A 140, B 150, C 160, D 170, and E 180 may include subscription websites that charge subscriptions for access to websites or merchant websites that enable a user to purchase products, such as books, videos, music, photographs and magazines. When user 10 clicks through to a web affiliate from an advertisement provided by the dispatcher 130 and makes a purchase at the web affiliate, the referring website earns a commission that can be a flat fee, a percentage of the revenue generated, a scaled percentage of revenue generated, or other commission.

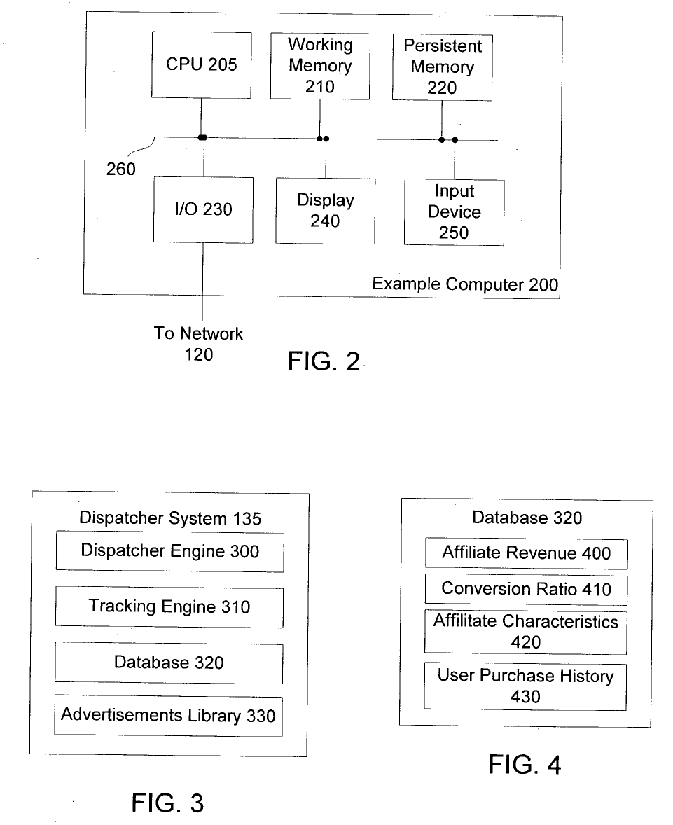

FIG. 2 is a block diagram illustrating an example computer 200 in accordance with the present invention. In an embodiment of the invention, each of website α 110, website β 115, web affiliates A 140, B 150, C 160, D 170, E 180, dispatcher 130 and user 10 may include or be resident on example computer 200. The example computer 200 includes a central processing unit (CPU) 205; working memory 210; persistent memory 220; input/output (I/O) interface 230; display 240 and input device 250, all communicatively coupled to each other via system bus 260. CPU 205 may include an Intel Pentium® microprocessor, a Motorola Power PC® microprocessor, or any other processor capable to execute software stored in persistent memory 220. Working memory 210 may include random access memory (RAM) or any other type of read/write memory devices or combination of memory devices. Persistent memory 220 may include a hard drive, read only memory (ROM) or any other type of memory device or combination of memory devices that can retain data after example computer 200 is shut off. I/O interface 230 is communicatively coupled, via wired or wireless techniques, to network 120. In an alternative embodiment of the invention, I/O interface 230 may be directly communicatively coupled to a server or computer, thereby eliminating the need for network 120. Display 240 may include a cathode ray tube display or other display device. Input device 250 may include a keyboard, mouse, or other device for inputting data, or a combination of devices for inputting data.

One skilled in the art will recognize that the example computer 200 may also include additional devices, such as network connections, additional memory, additional processors, LANs, input/output lines for transferring information across a hardware channel, the Internet or an intranet, etc. One skilled in the art will also recognize that the programs and data may be received by and stored in the system in alternative ways.

FIG. 3 is a block diagram illustrating the dispatcher system 135 of the dispatcher 130 (FIG. 1). Dispatcher system 135 comprises a dispatcher engine 300, a tracking engine 310, a database 320, and an advertisements library 330. Dispatcher engine 300 receives requests for affiliate advertisements from a website, such as website α 110 or website β 115. The dispatcher engine 300 then determines the affiliate offering the maximum potential revenue generation based on data stored in database 320, such as prior revenue generated by each affiliate, conversion ratio of affiliate website visitors to purchasers, affiliate characteristics and other factors. The determination can be made using an exponential or linear scoring technique using data from the database 320. The determination process will be discussed in further detail in conjunction with FIG. 5. Once the determination is made, the dispatcher engine 300 sends an advertisement corresponding to the affiliate offering the maximum potential revenue generation to the requesting web server.

Tracking engine 310 tracks revenue generated for the referring website, such as websites α 110 and β 115, by affiliates, such as web affiliates A 140, B 150, C 160, D 170, and E 180 and updates database 320 accordingly. To track revenue, tracking engine 310 may receive revenue generation data from affiliates. In addition, tracking engine 310 tracks user purchase history, such as purchases at specific affiliates and related charge-backs and then updates database 320 accordingly. As will be discussed further in conjunction with FIG. 4, database 320 may include affiliate revenue data 400 (FIG. 4); conversion ratio data 410 (FIG. 4); affiliate characteristics data 420 (FIG. 4); and user purchase history data 430 (FIG. 4). Database 320 may also be pre-populated with data as will be discussed in further detail below.

Advertisement library 330 includes advertisements, such as banner advertisements, for web affiliates, such as web affiliates A 140, B 150, C 160, D 170, and E 180. Each advertisement includes linking data, such as a web address, to a corresponding web affiliate. If a user clicks the advertisement, his or her web browser will automatically load a web page corresponding to the linking data.

FIG. 4 is a block diagram illustrating the database 320 of the dispatcher system 135 (FIG. 3). Database 320 comprises affiliate revenue data 400; conversion ratio data 410; affiliate characteristics data 420; and user purchase history data 430. Affiliate revenue data 400 includes data corresponding to revenue generated by affiliates for referring websites. Conversion ratio data 410 includes data corresponding to how often referred users were converted into purchasers. Affiliate characteristics data 420 may include data corresponding to web affiliate characteristics, such as language of web affiliates, products offered by web affiliates, geographic location of web affiliates, etc. User purchase history data 430 may include the number of purchases for users at specific web affiliates, the amount of the purchases at the web affiliates, the amount of charge-backs from purchases and other data. User purchase history data 430 may also include demographic data of users such as age, preferred language, country of residence, etc.

In an embodiment of the invention, dispatcher engine 300 and tracking engine 310 may pre-populate database 320 with relevant data using an initialization routine. During the initialization, dispatcher engine 300, when receiving a request for an affiliate advertisement, sends a randomly selected affiliate advertisement to the requester. The tracking engine 310 then tracks whether a purchase was made and updates the database 320. The dispatcher engine 300 can process requests in this manner for any number of pre-specified requests. For example, dispatcher engine 300 can process the first 10,000 requests in this manner before processing requests in accordance with method 500 (FIG. 5) as discussed below.

FIG. 5 is a flowchart illustrating a method 500 for a dispatcher to choose a web affiliate to maximize potential revenue generation. First, a user, such as user 10, initiates (505) a visit to a web page from a website, such as website α 110 or website β 115, using a web browser, such as Internet Explorer. Next, a web server on the website visited identifies (510) the user, if possible, via a cookie residing on the user 10 or via other techniques. The web server then notifies (515) the dispatcher 130 (FIG. 1) of the visit and sends a user ID, if determined from the cookie, to the dispatcher 130. Next, the dispatcher engine 300 determines (520) an affiliate offering the maximum potential revenue generation based on data stored in database 320. The affiliate offering the maximum potential revenue generation is an affiliate website most likely to generate the most revenue for a referring website. Alternatively, the affiliate offering the maximum potential revenue generation may be an affiliate website most likely to generate any revenue for the referring website. In another embodiment of the invention, an affiliate may have multiple websites with different layouts and/or product lineups. Accordingly, the dispatcher engine 300 may also determine which website from a single affiliate is most likely to generate revenue for a referring website.

To determine the affiliate having the maximum potential revenue generation, the dispatcher engine 300 weighs various factors based on data stored in database 320. The dispatcher engine 300 can weigh the factors using a linear scoring technique (i.e., for each affiliate: Score_{affiliate=}

$${\sum }_{n = 1}^{m} {W}_{n} * {C}_{n} ,$$

wherein m is the number of factors defined for each affiliate, Cₙ is the relative factor score for each factor, and Wₙ is the weight assigned for each factor), an exponential scoring technique (i.e.,

$${Score}_{affiliate} = {\sum }_{n = 1}^{m} {C}_{n} * {2}^{( {W}_{n} - 1 )} ) ,$$

or any other technique for weighing factors. The factors, which may be stored in database 320, may include average revenue generated per click through, conversion ratio, potential revenue based on a scaled commission system, whether the language of the affiliate is the same as a user's, whether the affiliate is in the same country as a user, whether a user that clicked through has purchased anything from the affiliate during previous visits, whether the user has had a substantial number of charge-backs for the affiliate, whether the affiliate might offer products or services that may appeal to a user based on user demographic data, and other factors. Each factor can be assigned a different weight based on which factors are to be emphasized over others to increase revenue generation potential. Alternatively, all factors may be given equal weight.

Next, the dispatcher engine 300 sends (525) an advertisement corresponding to the identified affiliate, from advertisements library 330 or other source, to the web server. The advertisement may include a banner advertisement or any other type of advertisement for use with a web page. The advertisement includes a web address of the identified affiliate such that if a user clicks on the advertisement or otherwise activates the advertisement, the user's web browser will automatically load a web page from the affiliate's website. Further, the web address may also include an identifying string to identify the referring website to enable commission calculation and payment to the referring website.

The web server then displays (530) the received advertisement on the web page being viewed by the user. The user may then click through (535) the advertisement using his or her web browser. As the advertisement includes a link to the web affiliate, the web browser can automatically load the web affiliate's website using the link.

A user may then purchase (540) items such as videos, magazines, subscriptions, photographs, books, etc. at the web affiliate. The web affiliate then calculates (545) a commission for the referring website. The web affiliate can identify the referring website via a string of identifying data in the web affiliate's web address or via other techniques. The web affiliate can then store the commission data locally in a database. The web affiliate also sends (545) data identifying the amount of the commission to tracking engine 310. The tracking engine 310 can then update (550) database 320 with this data. The method 500 then ends.

The foregoing description of the illustrated embodiments of the present invention is by way of example only, and other variations and modifications of the above-described embodiments and methods are possible in light of the foregoing teaching. For example, all factors for determining an affiliate offering the maximum potential revenue generation may be considered equally instead of using a weighted score technique. Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
receiving, from a web server, a request for a website affiliate advertisement;
selecting a website affiliate based on potential referral revenue generation; and
sending, to the web server, an advertisement corresponding to the selected website affiliate.

2. The method of claim 1, wherein the selecting selects an affiliate based on maximum potential revenue generation using a weighted score analysis of a plurality of factors.

3. The method of claim 2, wherein the factors include past revenue generation, user purchase history, affiliate website characteristics, user demographic data and affiliate conversion ratios.

4. The method of claim 2, wherein the weighted score analysis uses a linear scoring technique.

5. The method of claim 2, wherein the weighted score analysis uses an exponential scoring technique.

6. The method of claim 1, further comprising receiving revenue generation data from the selected affiliate.

7. The method of claim 6, further updating a database with the received revenue generation data.

8. A machine-readable medium having stored thereon machine-readable code to permit a machine to effect a method, the method comprising:
receiving, from a web server, a request for a website affiliate advertisement;
selecting a website affiliate based on potential referral revenue generation; and
sending, to the web server, an advertisement corresponding to the selected website affiliate.

9. The machine-readable medium of claim 8, wherein the selecting selects an affiliate based on maximum potential revenue generation using a weighted score analysis of a plurality of factors.

10. The machine-readable medium of claim 9, wherein the factors include past revenue generation, user purchase history, affiliate website characteristics, user demographic data and affiliate conversion ratios.

11. The machine-readable medium of claim 9, wherein the weighted score analysis uses a linear scoring technique.

12. The machine-readable medium of claim 9, wherein the weighted score analysis uses an exponential scoring technique.

13. The machine-readable medium of claim 8, wherein the method further comprises receiving revenue generation data from the selected affiliate.

14. The machine-readable medium of claim 13, wherein the method further comprises updating a database with the received revenue generation data.

15. A system, comprising:
means for receiving, from a web server, a request for a website affiliate advertisement;
means for selecting a website affiliate based on potential referral revenue generation; and
means for sending, to the web server, an advertisement corresponding to the selected website affiliate.

16. A system, comprising:
a database capable to store data for use in selecting an affiliate having maximum potential referral revenue generation; and
a dispatcher engine, communicatively coupled to the database and a network, capable to receive, from a web server, a request for a website affiliate advertisement, select a website affiliate based on potential referral revenue generation; and send, to the web server, an advertisement corresponding to the selected website affiliate.

17. The system of claim 16, wherein the dispatcher engine is capable to select using a weighted score analysis of a data stored in the database.

18. The system of claim 17, wherein the dispatcher engine uses a linear scoring technique for the weighted score analysis.

19. The system of claim 17, wherein the dispatcher engine uses an exponential scoring technique for the weighted score analysis.

20. The system of claim 16, wherein the data includes past revenue generation, user purchase history, affiliate website characteristics, user demographic data and affiliate conversion ratios.

21. The system of claim 16, further comprising a tracking engine capable to receive revenue generation data from the selected affiliate.

22. The system of claim 21, wherein the tracking engine is further capable to update the database with the received revenue generation data.
